(19) United States
(12) Patent Application Publication
(10) Pub. No.: US 2008/0264963 A1
(43) Pub. Date: Oct. 30, 2008

(54) Automatic pellets dispenser with closing exit

(76) Inventor: Ioan Valentin Teodorescu, Plano, TX (US)

Correspondence Address: IOAN VALENTIN TEODORESCU, 3112 HOPI CT., PLANO, TX, 75074, US

(21) Appl. No.: 11/789,101

(22) Filed: Apr. 24, 2007

(51) Int. Cl. G07F 11/00

(52) U.S. Cl. 221/4; 221/12

(57) ABSTRACT

An automatic pellets dispenser having a container that stores the pellets, an evacuation chamber which is provided at the bottom with a horizontally moving platform activated in cycles, forward and backward, which performs the function of a conveyor, by a DC gear motor and a mechanical system which converts the circular motion into linear motion of the platform. The motor is activated by a timer which provides the timing and the amount of the pellets dispensed. At one end of the evacuation chamber is provided an exit for the pellets and a flexible wall to retain the pellets located on top of the platform. The entire assembly is located on top of a support which in turn is located on a base board.

### BACKGROUND OF THE INVENTION

1. Field of the Invention

This invention relates to automated dry food dispenser in form of pellets, seeds or grains at predetermined times and predetermined amounts.

Households with pets, particularly in United States, is growing each year. It can be a special problem for pets like dogs and cats being left alone for long time and having to wait to be fed. When the animals are pond fish or birds, the probability to be left alone is even higher because they do not need the presence of the owner or other human being in proximity like dogs and cats need. On the other hand for animals who can access themselves the food it is not recommended to leave at their disposition a large quantity of food.

2. Background

The prior art shows of dry food dispensers with different degrees of complexity. Generally these machines have a large reservoir to contain food and a mechanism, generally in the form of paddle wheel or in some cases a screw conveyor, that distributes a set quantity of food. A timer also allows for the food to be distributed at preset times. Variations between the different prior art can be found in the different ways by which food quantities are measured. For example, U.S. Pat. No. 5,303,672 by Morris, U.S. Pat. No. 4,079,699 by Longmore and U.S. Pat. No. 5,873,326 by Dave have a rotating wheel having sections that can be blocked to control the amount. This system is very prone to to pellets jamming.

U.S. Pat. No. 4,069,793, to Gower, teaches a pet feeding apparatus having a plurality of food containing tubes, each of which is opened at spaced time intervals by a trap door held closed by the rectangular plunger of an electrical relay connected in electrical series to an electrical timer. Upon receiving a signal from the timer, the plunger of the relay is retracted to allow the trap door to open by gravity to dispense pet food in one of the food tubes.

This system is complex and prone to jamming.

U.S. Pat. No. 6,273,027 by Watson uses a geared motor that opens an opening, this system is also prone to jamming.

U.S. Pat. No. 5,794,560 by Terenzi is directed to an automatic dog and cat feeder having an elongated housing enclosing a hopper in the upper portion thereof. Its lower end is the funnel outlet hole. A spring-loaded cone valve below the outlet prevents the dry pellets particular feed from being released. The cone-valve movement is solenoid operated with timers. The feed delivery system is housed in a container which in turn when in operation directs dry pellets particular feed to the exterior of the feeder into a feed dish.

U.S. Pat. No. 4,834,025 by Tum uses a tumbler and counterweight and requires manual adjustment as well as several trials and errors to get the right amount of food.

U.S. Pat. No. 4,363,291 by Harmsen uses a worm screw which requires two distinct programming, one for the duration of rotation of the worm screw and one for the duration of the flow. There is no mean to unblock potential jamming.

U.S. Pat. No. 4,733,634 by Hooser, teaches about an automatic feeder. The system is very complex.

U.S. Pat. No. 4,993,364 teaches about a food dispenser comprising a housing for containing feed, a feed measuring and dispensing device, and an outlet for directing feed to a desired location. The control actuates the rotating tube at desired times in one or more half turns.

U.S. Pat. No. 5,193,722 by Groya has a plurality of compartments but they are used for increasing the flow not increasing the quantity.

U.S. Pat. No. 5,363,805 by Wing employs an auger to dispense the pellets. The system does not provide the closing of the exit.

U.S. Pat. Application No. 20070000445, by Blais teaches about an automated machine for measuring and distributing pellets by using a downward tilt motion of a food tray, serving vanes for measuring the distributed pellets, and a two state of the tray in one state dispense and block the pellets from falling from the hopper and in the second state block the pellets to be dispensed and open the hopper to allow the pellets to fall into the measuring compartments.

While the above prior art illustrate and describe a number of approaches for automatically providing pellets for unattended animals, the mentioned approaches are generally complex and subject to breaking down. Moreover, they do not provide for a secure sealing of the system against moisture, insects or other agents, some of them are sensitive to the animal environment, difficult to operate, maintain and clean.

### FEATURES AND ADVANTAGES OF THE INVENTION

A first object of the present invention is to provide the ability to close the exit and perfectly seal the interior of the system in order to protect the pellets against moisture, insects or small animals. This feature will enable the machine to be used outside in bad weather, even for pond applications where the system is the most exposed to moisture, insects and mice.

A second objective of the present invention is to provide a very simple and robust design with a very low probability to break down, clog, or to get jammed and with ability to be easy maintained (for example cleaning) and not to crash the pellets during operation.

A third objective of this invention is to provide a machine which requires a low electrical power to be operated, for example a small battery.

A forth objective of this invention is to provide a machine that measures and program the amount of the pellets to be dispensed without employing complicated electromechanical devices, serving vanes, etc, and to accommodate different sizes of the pellets without changing the mechanical settings of the system.

A final object of this invention is to provide a low cost machine with no need for molding tools, just by using PVC pluming components.

### SUMMARY OF THE INVENTION

This invention can achieve all the above objective by using just a simple horizontally linear moving platform activated forward and backward by an electromechanical system which transform the circular motion into linear motion. This platform performs the following functions:
Stirs the pellets located at the bottom of the main container, thus avoiding the pellets to clog.
Transports the pellets on the top toward the exit during the horizontal forward movement, like a conveyor
Seals the system at the end of the horizontal forward movement.
Dispenses a determined amount of pellets located on the top during the horizontal backward movement similar with a conveyor
It performs the function of measuring the amount of pellets dispensed in one cycle which is the same regardless how full is the main container or the size of the pellets.

The pellets from the container fall through a window determined by the upper threshold on top of the horizontally moving platform. During the forward movement of the platform, the pellets are transported toward the exit end until the platform reaches the opposite end and seals the interior. During the backward movement, the pellets located on the top of the platform between the flexible retaining wall and the edge of the exit opening will fall into the exit opening and into the bowl. This represents the amount of pellets dispensed in one cycle.

In the backward position the pellets dispensed will be replaced by new pellets due to gravity falling from the container. The number of the cycles continues until the programed amount of pellets is dispensed.

The test demonstrated that the amount of pellets released in one cycle is independent of the amount and the size of the pellets present in the container. This is the simplest way to measure and to dispense pellets.

At the end of the last cycle the horizontally moving platform will always stop in the maximum forward position determined by the presence of a micro-switch, thus performing the function of closing and sealing the system.

Another embodiment of this invention assumes that it is not required to close the exit and seal the interior. The same machine can be used to dispense pellets by limiting the maximum forward movement of the platform to the exit edge and backward to the upper threshold. The pellets will be dispensed during the forward movement of the platform and the amount of the pellets dispensed in one cycle equals the amount of pellets present in front of the moving platform in the maximum backward position. This mode of operation is specified in claims 16, 17, 18. This embodiment does not require the retaining flexible wall and the anti-jamming feature implement for the first embodiment.

It is understood that the invention is not limited in its application to the details of the construction like sizes, materials used and to the arrangements of the components set forth in the following description or illustrated in the drawings.

### BRIEF DESCRIPTION OF THE PREFERRED EMBODIMENT

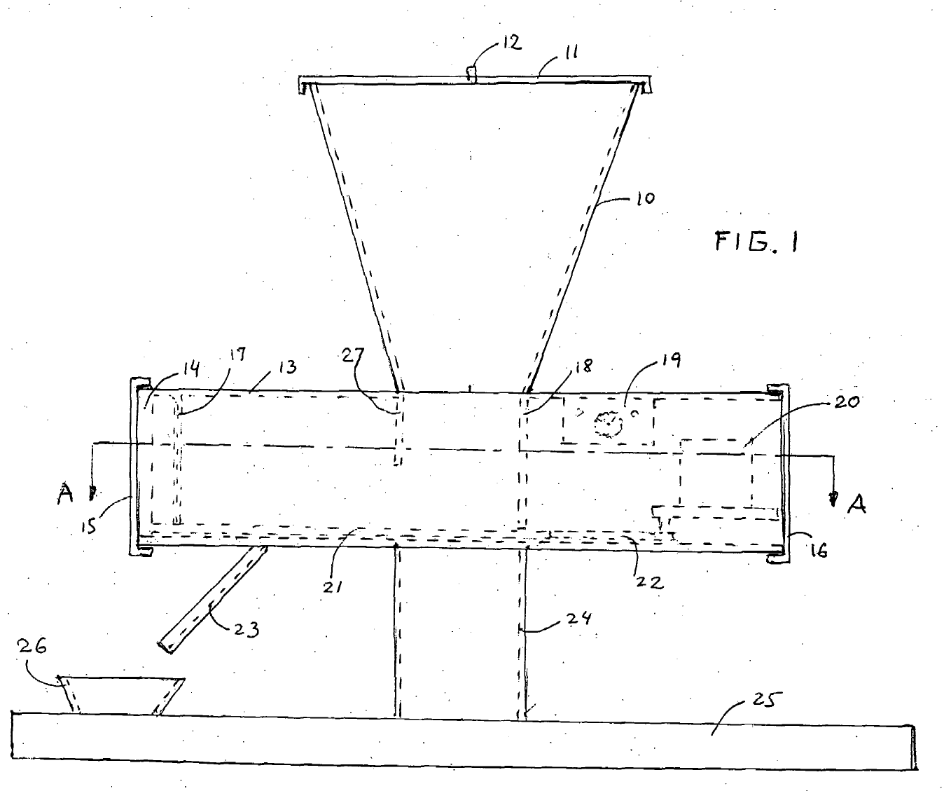

FIG. 1 Side view of the pellets dispenser.

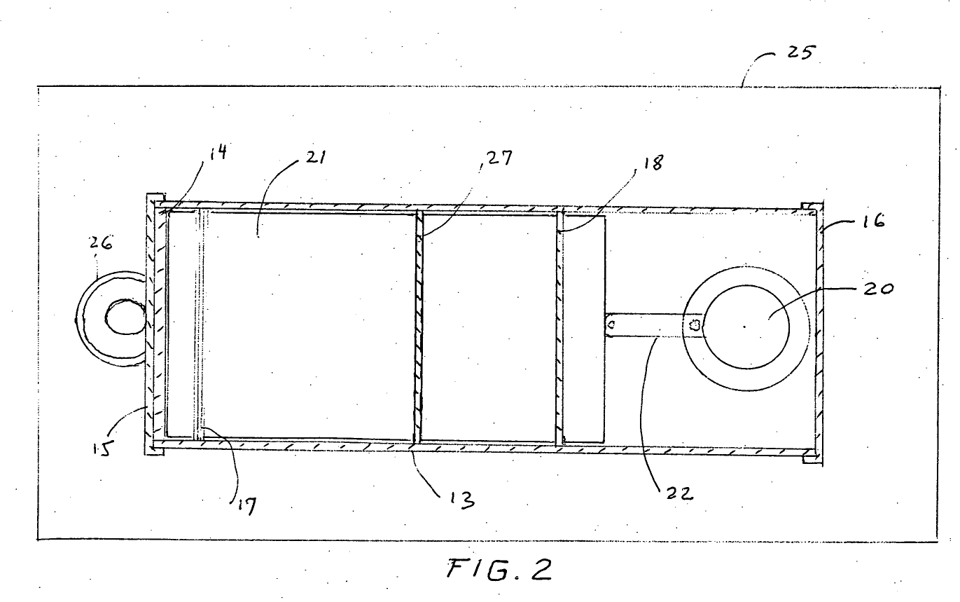

FIG. 2 Horizontal cross-section AA of the pellets dispenser represented in FIG. 1

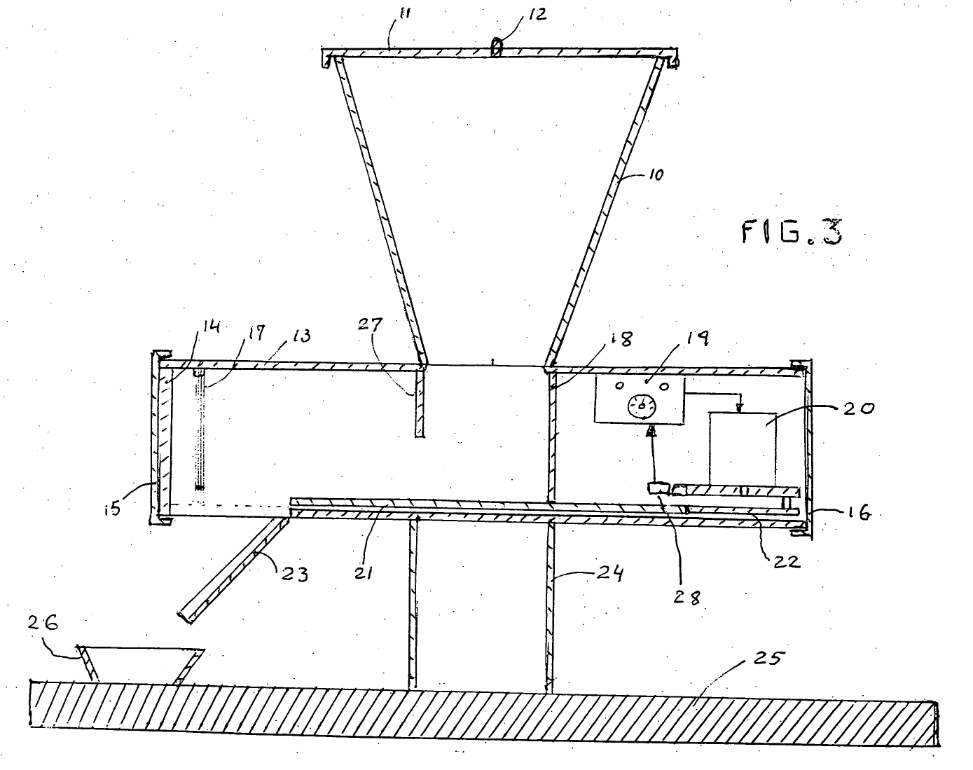

FIG. 3 Vertical cross-section of the pellets dispenser with closing exit, no pellets, and the horizontally moving platform in maximum backward position.

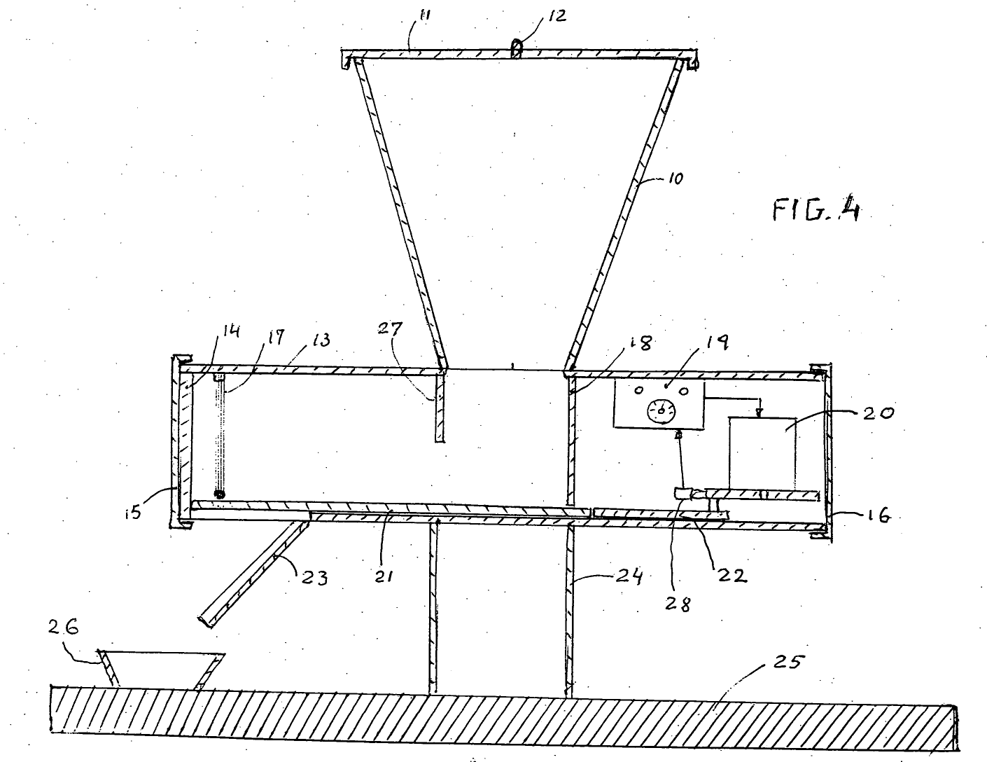

FIG. 4 Vertical cross-section of the pellets dispenser with closing exit, no pellets and the horizontally moving platform in maximum forward position.

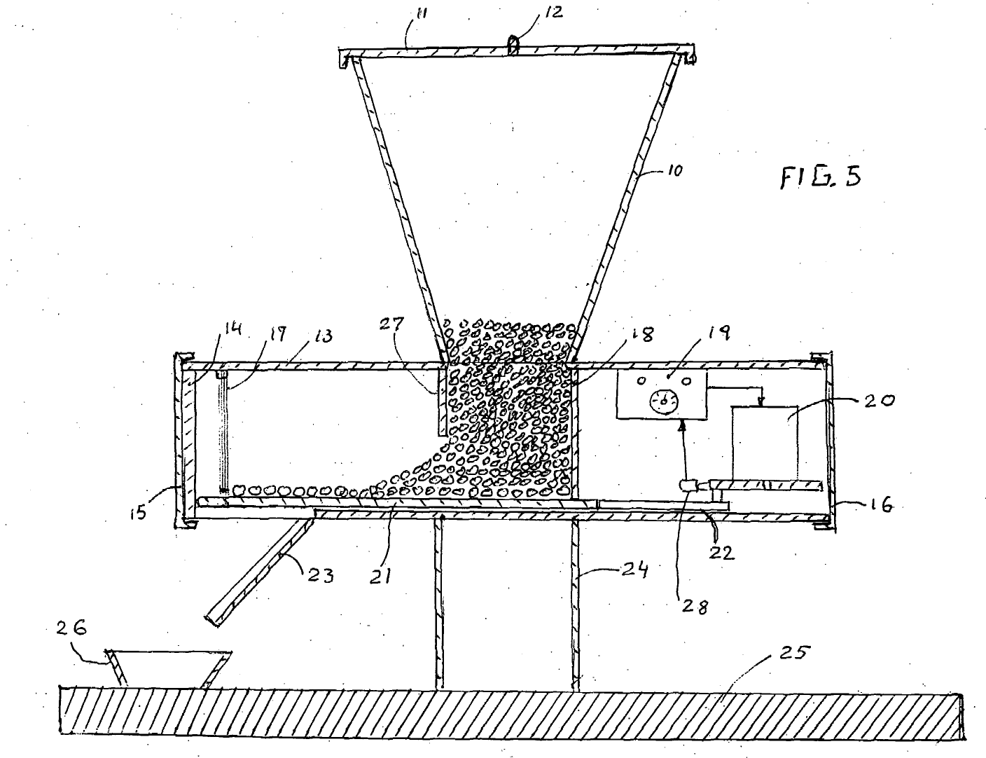

FIG. 5 Vertical cross-section of the pellets dispenser with closing exit, loaded with pellets and the horizontally moving platform in the maximum forward position.

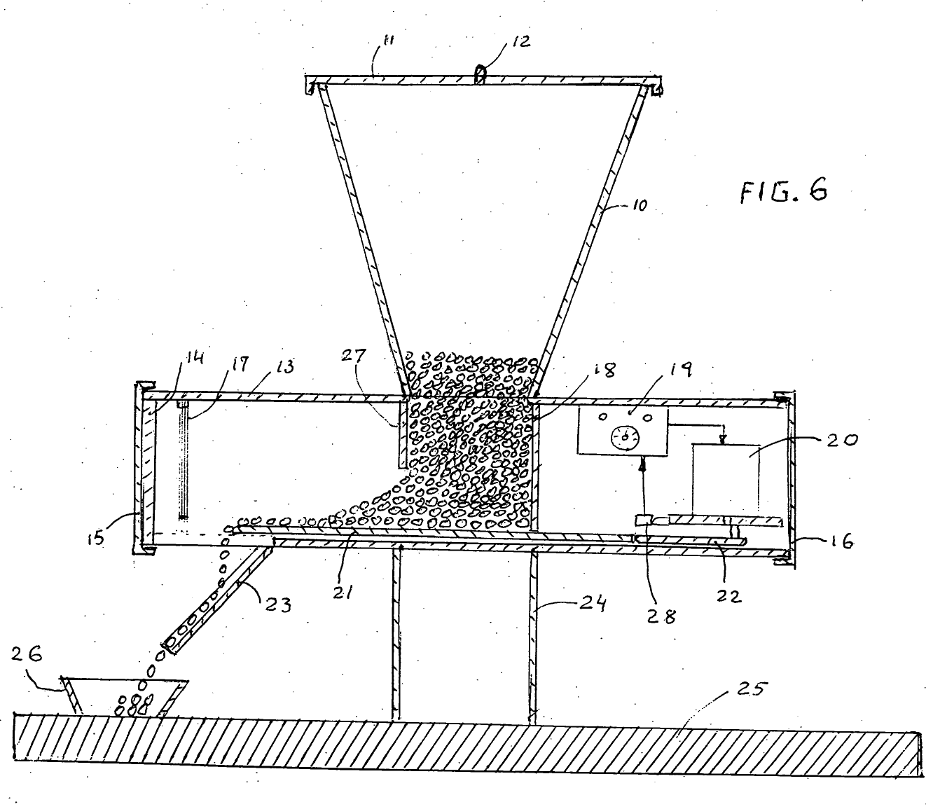

FIG. 6 Vertical cross-section of the pellets dispenser with closing exit, loaded with pellets and the horizontally moving platform in intermediary position (the pellets are discarded into exit).

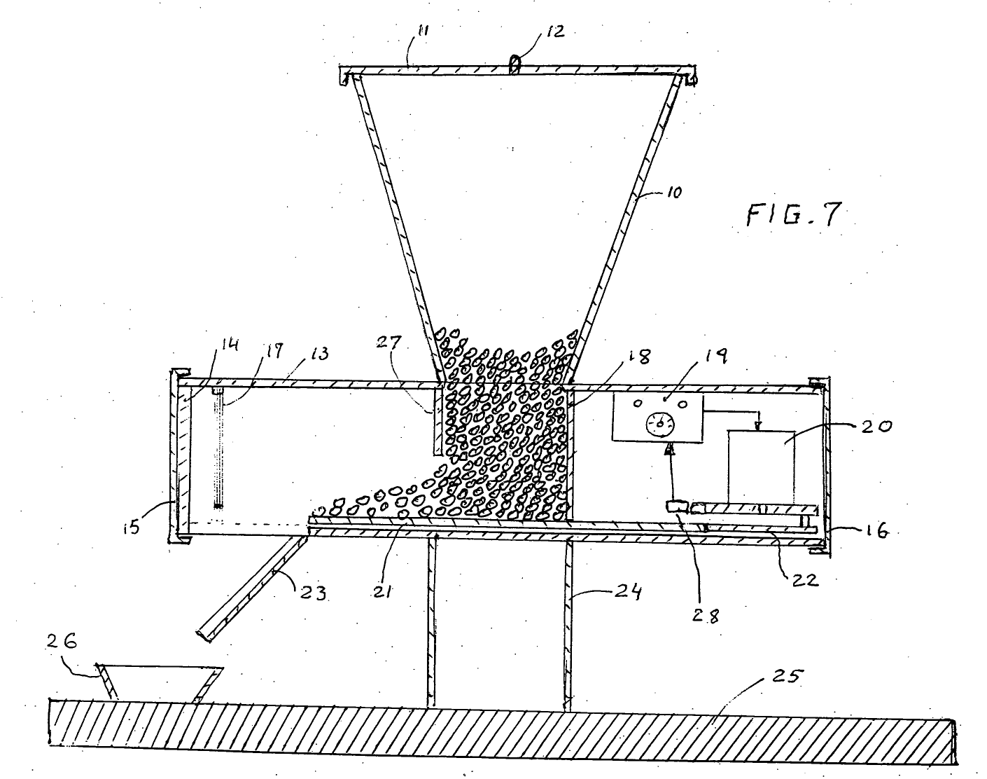

FIG. 7 Vertical cross-section of the pellets dispenser with closing exit, loaded with pellets and the horizontally moving platform in the maximum backward position.

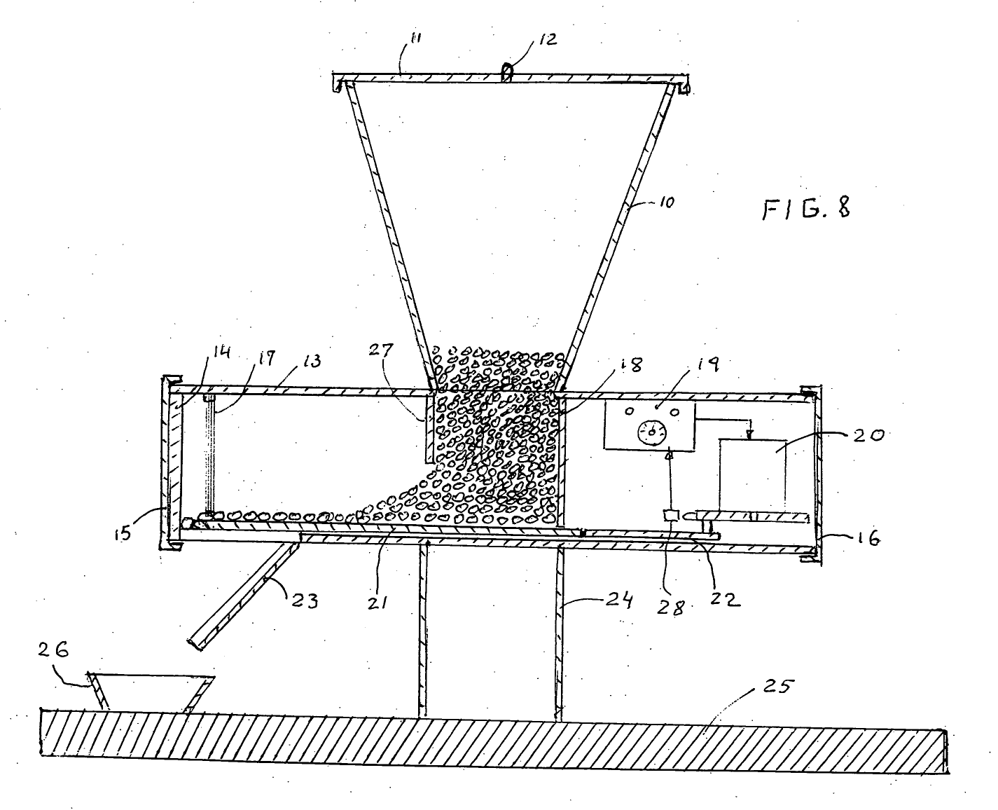

FIG. 8 Vertical cross-section of the pellets dispenser with closing exit, loaded with pellets and the horizontally moving platform jammed in forward position by a pellet accidentally caught between the edge of the platform and the sealing wall.

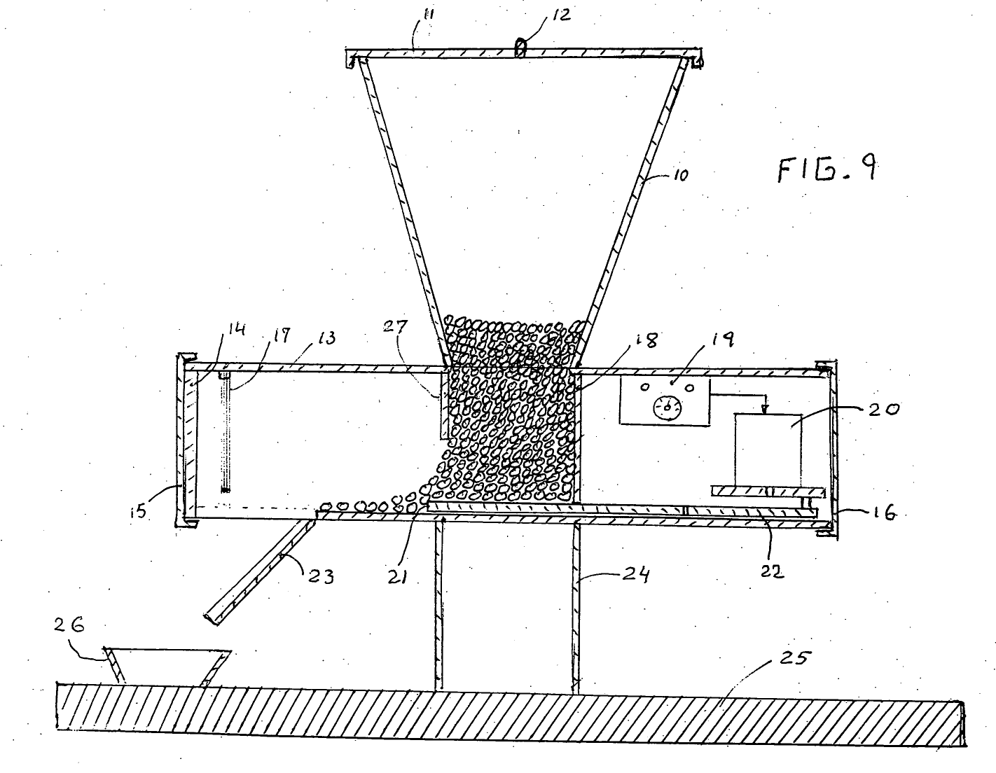

FIG. 9 Vertical cross-section of the pellets dispenser without closing exit, with pellets and the horizontally moving platform in the maximum backward position.

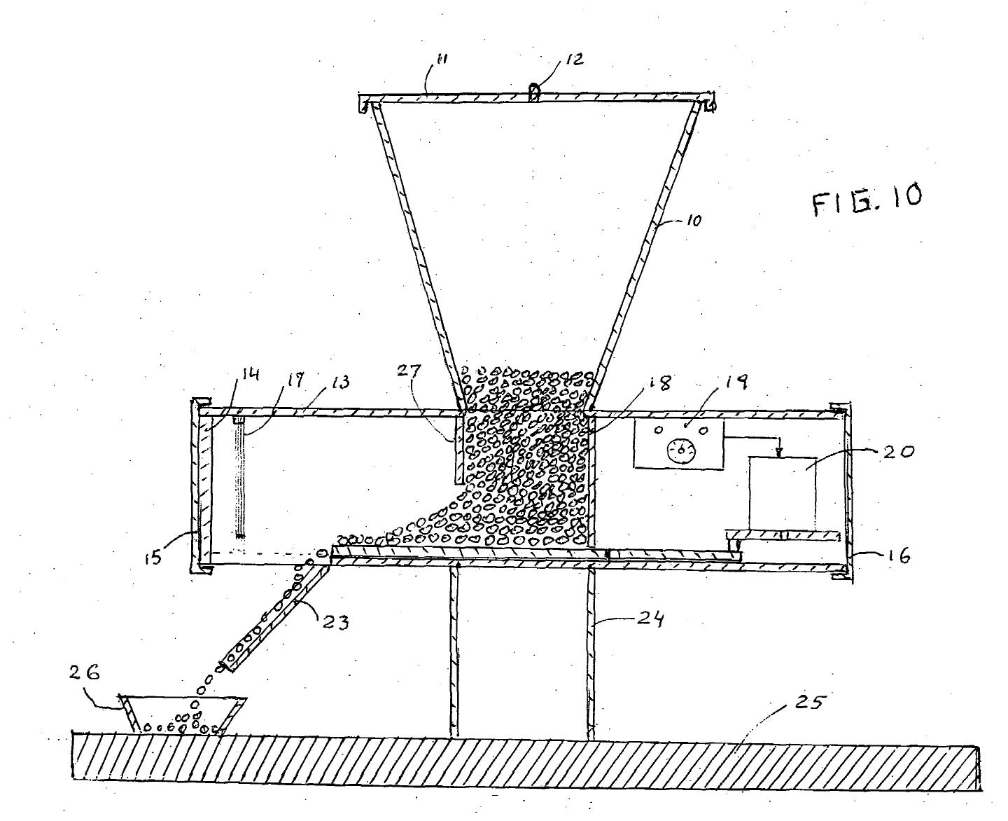

FIG. 10 Vertical cross-section of the pellets dispenser without closing exit, with pellets and the horizontally moving platform in the maximum forward position.

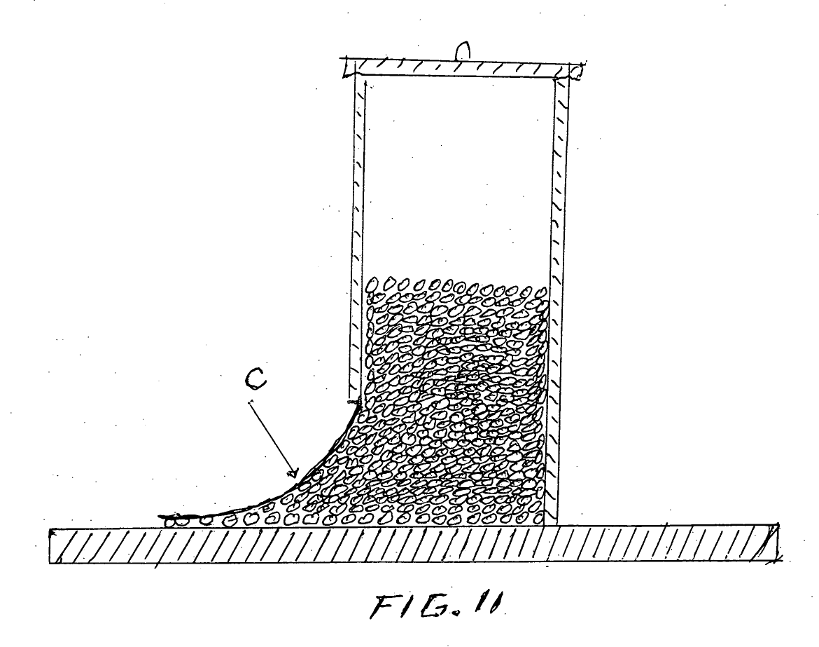

FIG. 11 Vertical cross-section through the distribution of the pellets with any amount of the pellets in the container and any size of the pellets.

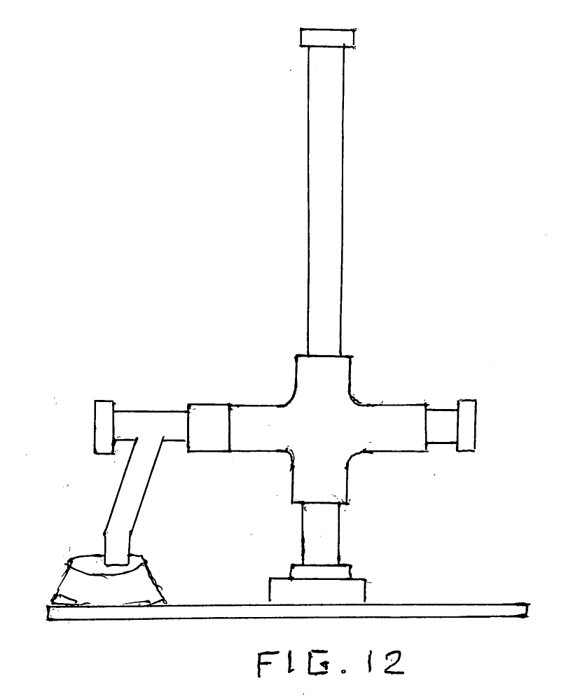

FIG. 12 A picture of the prototype build by using PVC plumbing components for the housing.

### DETAILED DESCRIPTION OF THE PREFERRED EMBODIMENT

FIG. 11 represents the basic theoretical principle of this pellets dispenser. Having a pellets container with an opening at the bottom and a horizontal platform, the pellets will pore out through the opening and create a horizontal distribution characteristic (curve C) which depends only on the size and shape of the opening and does not depend on the amount of the pellets present in the container or on the size of the pellets.

If at the bottom of the container is located a horizontally moving platform, one can approximately adjust the exit opening so, that on a defined segment of the platform will always lay approximately the same volume of pellets.

By moving this platform horizontally, it will transport, like a conveyor, the pellets located on the top away from the base of the container, up to the maximum forward position. During the backward movement, the pellets located on the top have no room to be transported back because the space on the top of the platform is occupied by the additional pellets falling out from the main container due to gravity, therefore they will be dispensed.

By limiting the length of the linear movement, only the pellets from a defined zone located on the top of the platform will be dispensed.

FIG. 1 An automatic pellets dispenser which has a container (10) with a lid (11) and a knob (12) an evacuation chamber (13) which is closed at the ends by the lids (15) and (16), a support (24) which in turn is located on the base platform (25).

The evacuation chamber is provided with an opening at one end and a guide (23) for the pellets to be discarded into the bowl (26).

FIG. 2 The evacuation chamber is provided at the one end with an opening for the pellets to be dispensed, a solid wall (14) intended to seal the chamber, a flexible wall (17) intended to retain the pellets located on the top close to the edge of the horizontally moving platform and to prevent them from getting close to the sealing wall (14).

Another wall (27), (upper threshold) will define the size of the exit window of the pellets from the main container (10) onto the top of the moving platform (21). This wall is necessary only for situations when the evacuation chamber (13) is employed from whatever is available from the marked and is not designed and build for this particular application.
Another wall (18) is provided which separate a location for the electromechanical devices, gear motor (20), mechanical devices (22), electrical components (19), etc. A small gap is provided at the bottom of this wall to allow the platform (21) to slide through.

FIG. 3 A horizontally moving platform (21), represented in the maximum backward position, is located at the bottom of the evacuation chamber (13), along with the electro-mechanical devices required to transform a circular motion into a linear motion (20, 28, 22).

FIG. 4 The horizontally moving platform (21) is represented in maximum forward position. In this position the edge of the platform touches the sealing wall (14), thus performing the sealing of the interior of the evacuation chamber (13) and the container (10).

FIG. 5 It represents the distribution of the pellets located on top of the moving platform (21) represented in the maximum forward position. The retaining wall does not allow the pellets to move beyond the wall, thus preventing some of them to be trapped between the edge of the moving platform (13) and the sealing wall (14).

FIG. 6 represents the way the pellets are dispensed during the backward movement of the platform (21). The pellets located on the backward moving platform will fall on to the guide (23) and then on the bowl (26) because the back space is occupied by additional pellets that fell due to gravity from the main container (10) on top on the moving platform (21).

FIG. 7 represents the moving platform (21) in the maximum backward position when and where the fall of the pellets will stop

FIG. 8 represents the situation, very seldom anyway, when a pellet escapes from the flexible retaining wall (17) and by accident is caught between the edge of the moving platform (21) and the sealing wall (14). Because the cycle of the platform was not completed, a spike will occur in the current fed to the DC gear motor. This spike will be used by the electronic circuits (19) to automatically and very fast reverse the current into the motor (20), thus reversing the direction of the movement of the platform for a very short time. This will be enough for the caught pellet to be liberated and dispensed into the exit opening The same circuits will automatically reverse again the current into the motor (20) until the end of the cycle determined by the micro-switch (28). This kind of jamming is very unlikely, but the system is provisioned to deal with it, without employing additional devices or components.

FIG. 9 represents another embodiment of the invention when it is not required to close the exit and to seal the system. The moving platform (21) is represented in the maximum backward position, with the pellets resting on the bottom of the evacuation chamber (13) in front of the moving platform (21). In this position, the pellets will not fall out from the evacuation chamber (13).

FIG. 10 represents the embodiment of the invention when it is not required to close the exit and to seal the system. The moving platform (21) is represented in the maximum forward position where all the pellets which were located in front of the moving platform (21) were pushed out on to the guide and into the bowl.

The embodiment represented in FIG. 9 and FIG. 10 does not require the presence of the flexible retaining wall (17) and the anti-jamming circuits.

The present invention compared with previous arts has the most robust and simplest way to measure and dispense the pellets, without crashing the pellets or clogging the system. Moreover, it is one of the few that can provide a perfect sealing of the interior and an easy access to visit, maintain and clean the unit.

The present invention does not require special components and the housing can be accommodated by using PVC plumbing components.

FIG. 12 A prototype was build and tested by using PVC plumbing components for the housing (see the attached picture). These will provide a very good protection of the unit in an animal environment against bites or scratches.

By using PVC pipes one can very simple change the capacity of the main container (10) and the hight of the evacuation chamber (13) just by changing the length of the respective pipes.

This patent is intended to claim only the idea, the basic principle used by this pellets dispenser. It is not intended to provide detailed implementations designs like hinges, systems to secure the basic platform, mechanical devices to adjust the hight and to secure the the bowl, etc.

1. An automatic pellets dispenser with closing exit comprising a container that stores the pellets, an evacuation chamber located at the bottom, a horizontally moving platform located at the bottom of the chamber activated in cycles, forward and backward by an DC gear motor through a mechanical system which transform the circular motion into linear motion, an opening at the bottom of one end of the chamber to allow for the pellets evacuation into a bowl, a timer which determine the timing and amount of the pellets dispensed, a flexible wall located at the exit end of the chamber to retain the pellets located on top of the platform and an upper threshold which is intended to adjust the size of the window between the storage container and the evacuation chamber.

2. An automatic pellets dispenser with closing exit of claim 1 wherein the chamber is provided at one end at the bottom with an opening to allow the evacuation of the pellets.

3. An automatic pellets dispenser with closing exit of claim 1 wherein the chamber is provided at each end with a removable lids to allow for visiting and cleaning of the chamber.

4. An automatic pellets dispenser with closing exit of claim 1 wherein at the exit end of the chamber is located a solid wall which seals the corresponding end.

5. An automatic pellets dispenser with closing exit of claim 1 wherein the chamber is provided with an upper threshold which adjust the size of the window between the container and the evacuation chamber such that the pellets will not flow out through the exit opening even when the platform is located in the maximum backward position.

6. An automatic pellets dispenser with closing exit of claim 1 wherein the chamber is provided at the exit end with a flexible wall (brush or rubber) which retain the pellets located on top of the moving platform and prevent the pellets to advance beyond the flexible wall.

7. An automatic pellets dispenser with closing exit of claim 1 wherein the chamber is provided with a separation wall between the bottom of the container and the area of the evacuation chamber which comprises the electromechanical components; this wall has an opening at the bottom which allow the moving platform to slide horizontally forward and backward.

8. An automatic pellets dispenser with closing exit of claim 1 wherein a horizontally moving platform is activated forward and backward, in the maximum forward position closes and seal the exit and in the maximum backward position stops at the edge of the exit opening.

9. An automatic pellets dispenser with closing exit of claim 8 wherein the said horizontally moving platform during the forward movement transports a determined amount of pellets toward the exit end and during the backward movement the platform dispenses the pellets into the exit opening.

10. An automatic pellets dispenser with closing exit of claim 8 wherein the said horizontally moving platform during the forward and backward movement stirs the pellets at the bottom of the container thus preventing the pellets to clog.

11. An automatic pellets dispenser with closing exit of claim 1 wherein at the one end of the chamber is located the timer, power supply DC gear motor and all the mechanical components which allow to convert the circular motor into linear motion.

12. An automatic pellets dispenser with closing exit of claim 1 wherein a micro-switch is provided to determine the maximum forward position of the moving platform.

13. An automatic pellets dispenser with closing exit of claim 8 which detects the jamming of the horizontally moving platform at the end of the closing cycle due to a pellet which accidentally passed the flexible retaining wall, and automatically reverses for short time the movement of the platform which will allow the trapped pellet to fall into the exit and the motor will automatically reverse again the direction of the platform movement up to the end of the closing wall.

14. An automatic pellets dispenser with closing exit of claim 9 wherein a spike in the current fed to the DC motor due to the jamming of the horizontally moving platform at the end of the forward cycle will trigger a relay which reverses the current for a short time, followed by another reversal of the current until the end of the cycle determined by the micro-switch.

15. An automatic pellets dispenser with closing exit of claim 1 wherein the amount of the pellets dispensed in one cycle equal with the amount of the pellets transported on top of the horizontally moving platform during the forward movement located between the retaining flexible wall and the edge of the exit opening; the pellets are disposed into the exit during the backward movement of the moving platform.

16. An automatic pellets dispenser without closing exit comprising a container that stores the pellets, an evacuation chamber located at the bottom, a horizontally moving platform located at the bottom of the chamber activated in cycles, forward and backward by an DC gear motor through a mechanical system which transform the circular motion into linear motion, an opening at the bottom of one end of the chamber to allow for the pellets evacuation into a bowl, a timer which determine the timing and amount of the pellets dispensed and an upper threshold which is intended to adjust the size of the window between the storage container and the evacuation chamber so that the pellets will not fall out with the said moving platform in the maximum backward position.

17. An automatic pellets dispenser without closing exit of claim 16 wherein the said horizontally moving platform in the maximum forward position does not go beyond the edge of the exit opening and in the maximum backward position stops at the edge of the upper threshold.

18. An automatic pellets dispenser without closing exit of claim 17 wherein the amount of pellets dispensed during the forward movement of the said moving platform in one cycle equals the amount of pellets located in front of the said moving platform in the maximum backward position.
